(19) United States
(12) Patent Application Publication
(10) Pub. No.: US 2024/0335867 A1
(43) Pub. Date: Oct. 10, 2024

(54) GEOLOGICAL SEQUESTRATION OF BATTERY RECYCLING WASTES

(71) Applicant: Austin Elements, Inc., Houston, TX (US)

(72) Inventors: Quanxin Guo, Houston, TX (US); Xiaochun Jin, Houston, TX (US); Yang Xia, Houston, TX (US)

(73) Assignee: Austin Elements, Inc., Houston, TX (US)

(21) Appl. No.: 18/628,479

(22) Filed: Apr. 5, 2024

Related U.S. Application Data
(60) Provisional application No. 63/494,599, filed on Apr. 6, 2023.

(51) Int. Cl. B09B 1/00; B09B 3/30; B09B 3/70; B09B 5/00; B09B 101/16

(52) U.S. Cl. CPC B09B 1/008; B09B 3/30; B09B 3/70; B09B 5/00; B09B 2101/16

(57) ABSTRACT

A method of preparing an injection slurry for the sequestration of battery recycling waste includes contacting at least one battery recycling waste stream with an optional liquid, thereby forming a slurry, screening the slurry thereby forming a screened slurry, conditioning the screened slurry thereby forming a conditioned slurry, and determining whether a threshold injection criterion of the conditioned slurry has been met. The threshold injection criterion has been met, an injection slurry is thereby formed. A method of sequestering battery waste includes introducing an injection slurry including battery recycling waste into a subsurface structure at a depth of at least 500 m.

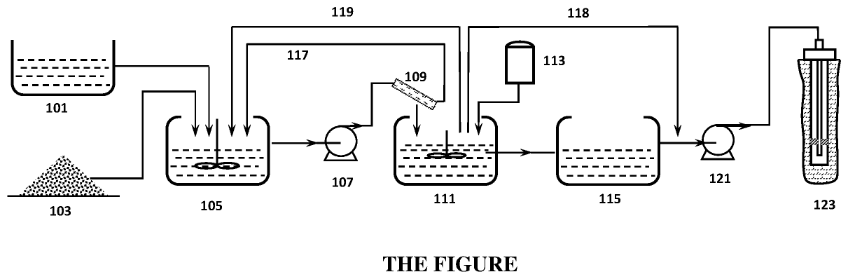

### BACKGROUND

The demand for lithium is surging due to the transition to electric vehicles and the growth in consumer electronics and power storage. There is a growing gap between the demand and supply of lithium, in addition to being a very limited resource as a rare element. Lithium-ion batteries (LIBs) are a family of rechargeable battery types in which lithium ions move from the negative electrode to the positive electrode during discharge and back when charging. LIBs consist of several components, typically including case, cathode, anode, Cu and Al foils, current collectors, electrolyte, binder, and separator that include valuable materials such as Li, Ni, Co, Mn and graphite. Therefore, those materials are the major targets during the spent LIBs recycling process, while the other components need to be removed in order to produce qualified products.

Over the past decades, several LIB recycling processes have been established. In traditional processes, efficient recycling of spent LIBs requires complicated processes that involve different types of technologies, such as physical separation, hydrometallurgy, and pyrometallurgy. These processes are then followed by a sophisticated hydrometallurgical process, which is normally required to remove the contaminants, separate the valuable components, and produce battery-grade products through several different steps, such as leaching, de-contamination, solvent extraction, evaporation, crystallization and precipitation.

The complexity of battery recycling leads to the generation of large amounts of gaseous, solid, and liquid waste. The negative environmental impact of the gaseous waste can be eliminated by combustion at sufficiently high temperatures; however, more sustainable approaches are required to manage the solid and liquid waste. The wastes from LIB recycling and precursor production must be properly managed to protect the environment in a cost-effective manner. Currently, the most common method for disposing the wastes is to use landfills. Using landfill for disposing the battery recycling and precursor production wastes is costly and limited by the availability of a landfill. Transport of the wastes to landfills can be costly and has negative health, safety and environmental (HSE) impacts to communities, from generating harmful gases to dusts and traffic safety along the way. Additionally, Na₂SO₄ waste with bacteria can result in strong foul odor even at very low concentration. Thus, there remains a need for a more economical and environmentally sustainable method for disposal of liquid and solid battery recycling waste streams.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of preparing an injection slurry for sequestration of battery recycling waste, that includes the formation of a slurry that is screened and conditioned to determine if an injection criterion has been met.

In another aspect, embodiments disclosed herein relate to a method of sequestering battery waste, the method including the introduction of an injection slurry into a subsurface structure at a depth of at least 500 m.

Other aspects and advantages of the claimed subject matter will be apparent from the following description and the appended claims.

### BRIEF DESCRIPTION OF DRAWINGS

The FIGURE shows a process flow diagram according to one or more embodiments.

### DETAILED DESCRIPTION

Embodiments disclosed herein are directed to a method of conditioning battery recycling waste streams for geological sequestration and sequestering said conditioned waste. The demand for lithium is surging quickly from transition to electric vehicles (EVs) and growth in consumer electronics and power storage. Battery recycling to recover and supply lithium will greatly reduce demands on mining additional lithium. LIBs consist of several components that serve different functions in LIBs and contribute different proportions to the overall manufacturing cost of LIBs. The cathode and anode are major contributors to the overall cost, primarily due to the high cost of raw materials, such as Li, Ni, Co, Mn, and graphite. Therefore, those materials from battery production processes are the major targets for recycling during the spent LIBs recycling process. Lithium-ion battery recycling precursor and battery production processes produce a lot of wastes, such as sodium sulfate (Na₂SO₄), iron phosphate (FePO₄), graphite, among others. The battery recycling waste stream can be a mixture of the aforementioned wastes and is generally not pure chemicals. Disposal of these battery production process wastes is costly and can have large negative impacts on the environment. In order to overcome these barriers, the present disclosure provides a method of conditioning battery recycling waste streams for geological sequestration. The use of geological sequestration of conditioned battery recycling waste streams may advantageously allow for more environmentally friendly and cost-effective long-term storage and disposal of battery recycling waste streams.

Embodiments disclosed herein relate to methods of preparing injection slurries from battery recycling waste streams that are conditioned to be suitable for geological sequestration by injection into subsurface structures. The subsurface structure may be an injection well into an oil or gas productive formation. However, in other embodiments, the subsurface structure may be an injection well into a non-productive formation.

Referring to the FIGURE, a generalized process flow diagram of a method in accordance with one or more embodiments is shown. In the embodiment shown in the FIGURE, battery recycling waste streams 101 and 103 are collected in a vessel 105, such as an agitated slurry fabrication vessel, alone or in combination with a liquid to form a slurry. In the embodiment shown in the FIGURE, waste stream 101 is a liquid waste stream and waste stream 103 is a solid waste stream. However, any combination of solid and/or liquid wastes may be treated with the disclosed method. The slurry is fed to screener 109 containing a sizing element. Materials larger than the sizing element are recycled back to upstream steps as indicated by process line 117. Materials smaller than the sizing element thereby form a screened slurry in vessel 111. One or more chemical additives 113 is added to the screened slurry to form a conditioned slurry in vessel 111. Lastly, a threshold injection criterion is used to determine if the conditioned slurry is suitable for injection into a subsurface structure.

In one or more embodiments, the method of preparing an injection slurry for geological sequestration may be performed continuously; however, in other embodiments, the method may be performed in batches.

As mentioned above, the battery recycling waste stream (101 and/or 103) is charged into vessel 105. According to one or more embodiments, the battery recycling waste steam may comprise at least one of a solid component and a liquid component. For example, the battery recycling waste steam may be a mixture of solids and liquids. In one or more embodiments, the battery recycling waste stream solid components may be selected from the group consisting of sodium sulfate, iron phosphate, graphite, plastics, slags, sludges, undissolved materials in a leaching process, precipitants from an evaporation process, filtered solids of size larger than 2 mm, and mixtures thereof. Undissolved materials include but are not limited to plastics, graphite when they have a particle size large enough that forms a precipitate (e.g., larger than about 2 mm). Precipitants may include but are not limited to Na₂SO₄. FePO₄, Al(OH)₃, Fe(OH)₃, among other slags generated from recycling. In one or more embodiments, the liquid components may be selected from the group consisting of dissolved salts, graphite when the graphite has a particle size small enough such that it is suspended in a liquid medium, suspended fine particles, and liquid chemicals such as Na₂SO₄, NaOH, wastewater containing graphite and other chemicals used in battery recycling reactions that are spent and cannot be used again. Some chemicals may be both a solid and a liquid component. For example, precipitated Na₂SO₄ may be a solid component whereas dissolved Na₂SO₄ may be a liquid component.

As mentioned above, the battery recycling waste stream may optionally be mixed with liquid to form a slurry and to achieve suitable rheological requirements for subsurface injection. In particular, for example, to be injected downhole, the slurry needs to have certain requirements for viscosity and solid content, to ensure it is compatible with the formation in which it may be injected and stored. Other slurry characteristics include those similar to what is used in cuttings reinjection where drill cutting waste is injected downhole. Typically, the slurry may have a pH range of 2 and 12, such as from the lower limit of any of 2, 3, or 4, to an upper limit of any of 10, 11 or 12, where any lower limit can be used in combination with any upper limit. The slurry may have a Marsh funnel viscosity ranging from 25 to 90 seconds, such as from the lower limit of any of 25, 35, or 50 seconds, to an upper limit of any of 70, 80 or 90 seconds, where any lower limit can be used in combination with any upper limit. The slurry may have a solids content up to 40% by volume if particle size is less than 500 μm or up to 30% if particle size is larger than 500 μm, such that the pumping rate may range from the lower limit of any of 100, 250 or 500 gallons per minute to an upper limit of any of 1,000, 1,500 or 2,000 gallons per minute, where any lower limit can be used in combination with any upper limit.

According to one or more embodiments, the liquid may be water, a battery recycling process stream, or combinations thereof. The liquid, waste stream or mixtures thereof may include Na₂SO₄ solution, wastewater containing graphite, liquid containing Co, Ni, Mn, Fe and others.

According to one or more embodiments, in addition to contacting the battery recycling waste stream and optional liquid to form a slurry, which takes place in vessel 105, the contacting may further comprise mixing and/or grinding. The mixing and/or grinding may be performed until a slurry having the rheological properties for downhole injection is obtained. Grinding requirements may depend on waste characteristics, injection formation properties, and cost of grinding. For example, if the injection formation has low porosity and permeability, grinding may be required. It is also envisioned that oversized solids may be separated from the slurry (and not ground) and disposed of by other more cost-effective disposal options if grinding is very costly, and the quantity of over-sized portions of the solid waste is not too much and can be disposed of more cost effectively using such other disposal options. As such, the waste stream and the optional liquid may be ground or mixed as needed. The mixing and/or grinding may be accomplished using any means known in the art, such as agitators and other suitable mixing and/or grinding elements.

Subsequent to slurry formation, the slurry is fed to the inlet of a pump 107. According to one or more embodiments, the pump may comprise mixing and/or grinding elements. The discharge of the pump 107 is connected to the inlet of screener 109 that includes sizing elements. According to one or more embodiments, the screener separates materials larger than the threshold size, ranging from a lower limit of few hundred microns to an upper limit of 2 mm, such as from a lower limit of any of 300, 400 or 500 microns to an upper limit of any 1, 1.5 or 2 mm, where any lower limit can be used in combination with any upper limit. Materials larger than the threshold size may be discharged to an outlet connected to a process line 117 and returned to previous contacting and screening steps. In one or more embodiments, the screener discharges materials smaller than the threshold size into vessel 111 to form a screened slurry. According to one or more embodiments, the screening step may take place with screeners in series, especially in cases where the waste generation rate is relatively low. However, in other embodiments, and in particular when the waste generation is relatively high, the screening step may take place with screeners operating in parallel.

Following screening, the screened slurry may be conditioned in vessel 111, optionally undergoing a second contacting step with the addition of one or more chemical additives 113 to modify the rheology of the slurry. According to one or more embodiments, the one or more chemical additives may include but are not limited to biocide, corrosion inhibitor, pH adjuster, viscosifier, others and combinations thereof. According to one or more embodiments, the residence time for conditioning to form a conditioned slurry is in the range from 0 minutes to hours, or any amount of time suitable for the slurry to react with the one or more chemical additives to modify the slurry rheology. However, according to one or more embodiments, the screened slurry may not be contacted with chemical additives.

Following conditioning, the conditioned slurry is discharged into a holding vessel 115 of the FIGURE or vessel 115 may be bypassed and it may be discharged directly to the inlet of a pump 121 as shown by arrow 118. In embodiments involving continuous production of injection slurry, the injection slurry may be discharged into the inlet of pump 121 prior to being fed to a subsurface structure 123. However, in embodiments involving the production of injection slurries in batches, the injection slurry may be discharged into vessel 115 before being fed to the subsurface structure 123 using pump 121.

Once the conditioning of a slurry is completed, the conditioned slurry may be analyzed to determine slurry characteristics. Slurry characteristics may be determined using an inline analyzer or by performing analyses using an aliquot from the conditioned slurry. Relevant slurry characteristics include but are not limited to slurry viscosity, specific gravity, percent solids, particle size of suspended particles or other properties known in the art that may be important for slurry injection downhole. According to one or more embodiments, the viscosity of the slurry and particle size of the suspended particles should be optimized to prevent the settling of smaller particles after injection. As mentioned above, the slurry may have a Marsh funnel viscosity between 25 and 90 seconds, pH between 2 and 12, solid content less than 40% by volume and particle size smaller than 2 mm. However, particular requirements on any specific implementation of the described method may depend on the formation into which the slurry is injected. For example, if the injection formation has good permeability and the injection operation can be done at high pumping rates, then the requirements on slurry viscosity and particle size can be relaxed as the high pumping rate will be able to carry the large solid particles into the injection formation even with low slurry viscosity.

The above slurry characteristics are used to determine if the conditioned slurry meets a threshold injection criterion making it eligible for ultimate geological sequestration. As will be appreciated by those skilled in the art, in order to be sequestered in subsurface environments, a slurry must have suitable characteristics for injection processes and ultimate storage downhole. As such, methods described herein include a step in which the slurries are tested to determine whether they have suitable characteristics for geological sequestration.

Referring back to the FIGURE, process line 119 may be used to return the conditioned slurry to repeat the above-described slurry preparation process. In particular, the contacting, screening, conditioning and determination steps may be repeated when the slurry characteristics do not meet the threshold injection criterion thereby rendering the conditioned slurry unsuitable for injection or the pumping procedure must be modified for the slurry characteristics. The threshold injection criterion may contain parameters related to slurry pH, slurry viscosity, solid particle size, solids content, among others and combinations thereof. The range of these parameters, as mentioned above, include a pH between 2 and 12, a Marsh funnel viscosity between 25 and 90 seconds, a solid content between 0 to 40% by volume, and a solid particle size between 300 μm and 2 mm. The specific slurry quality control requirements are generally project dependent. As an example, if the injection formation accepts waste slurry at high rates, the quality control requirement for the slurry viscosity and the particle size can be relaxed as the slurry can transport larger particles to the injection formation at a higher pumping rate. When the slurry characteristics meet the threshold injection criterion, according to one or more embodiments, an injection slurry is formed. However, in other embodiments, the slurry characteristics do not meet the threshold injection criterion and are returned to upstream processing. The slurry may be reprocessed using the process described above any number of times until the threshold injection criterion is met.

### Sequestering Battery Waste

The battery recycling waste streams may be processed to ultimately form an injection slurry, and the injection slurry may be injected into a subsurface structure for sequestration. As used herein, a “subsurface structure” refers to a geological structure in the earth's crust. The subsurface structures described herein are generally at a depth ranging from about 500 m to about 2500 m. However, government regulations may also dictate a minimum depth required for sequestration.

As will be appreciated by those skilled in the art, different subsurface environments will require different injection parameters for introducing the slurries downhole. For example, an injection zone with high permeability may require a higher pumping rate and a slurry with larger particles than for injection zone with low permeability. In one or more embodiments, the subsurface structure is, therefore, tested to determine the target injection zone and injection pressure. Additional testing may include leak-off test, step-rate test, core tests, and testing not limited to determining the substructure depth, pressures, temperatures throughout the substructure, lithology, rock mechanics, porosity, permeability or any other related to the size or capacity of the substructure. These parameters may then be incorporated into models or simulators for review and engineering design.

For the injection of the injection slurry, subsurface specific injection parameters need to be determined in order to properly inject the slurry into the subsurface environment. According to one or more embodiments, the subsurface specific injection parameters may include parameters related to injection depth, temperature, pressure, rate of injection, shut-in period, injection period, capacity or any other parameter pertinent to the art.

According to one or more embodiments, the injection slurry is introduced to a depth of at least 500 m.

According to one or more embodiments, the injection slurry may be introduced to the subsurface structure at a temperature less than 350° F.

The pressure at which the injection slurry may be introduced into the subsurface structure may vary. However, the maximum allowed injection pressure may be determined from the lesser of that which is permitted according to environmentally pertinent governing bodies or that of the maximum design pressure of the equipment used to inject the injection slurry. According to one or more embodiments, the injection slurry may be introduced to the subsurface structure at a pressure of no more than the maximum allowed injection pressure. According to one or more embodiments, the injection slurry is injected into the subsurface structure at a pressure sufficient to create fractures.

The pumping rate is optimized to prevent the settling of suspended particles in the slurry and to account for the rate of injection slurry production and for the maximum allowed injection pressure. Alternatively, the pumping rate may be determined through the use of a model or simulator. According to one or more embodiments, the injection slurry may be introduced to the subsurface structure at a rate of injection ranging from about 100 gallons per minute to 2000 gallons per minute. One of ordinary skill would recognize that if the battery recycling plant has a capacity of 10,000 tonnes/year, the pumping rate may be in the order of 5 to 10 bbl/min (barrels per minute). However, if the plant has a capacity of 100,000 tonnes/yr, the rate could be anywhere from about 10 to 50 bbl/min.

In embodiments in which the injection of waste includes creating fractures in a subsurface environment, shut-in periods may be utilized to allow for the pressure to drop and the fracture to close. According to one or more embodiments, the injection slurry may be introduced to the subsurface structure and undergo a shut-in period that is adequate for the fracture to close. For example, structures with high permeability will require a shorter shut-in period than that of a structure with low permeability. Thus, typically, shut-in periods can range from hours to days, such as 4 hours to 10 days.

According to one or more embodiments, the introduction of the injection slurry may be facilitated using any properly engineered hydraulic pump or other surface injection facility that is appropriate for the handling of the slurry. For example, a pump may be used to feed the injection slurry through tubing into the subsurface structure, which is also able to operate on a continuous basis to monitor any of rate, total volumes, pressure, density and temperature in real-time may be used.

For the embodiments disclosed herein, acquiring data for real-time monitoring system and apparatus may be used to record and monitor the introduction of the injected slurry. The parameters monitored while acquiring data for real-time monitoring include but are not limited to injection pressure at the inlet and at appropriate locations throughout the subsurface structure, subsurface structure build-up pressure, pumping rate, and slurry density. Other parameters that may require monitoring due to environmental constraints include nearby well pressure, nearby fluid levels, parameters for quality assurance, analysis and regulatory reporting. According to one or more embodiments, these same parameters may be monitored periodically, or alternatively, not at all.

As mentioned above, the methods of the present disclosure may be used to select and/or prepare subsurface structures for the sequestration of battery recycling waste streams. According to one or more embodiments, methods may include selection of a permeable and porous subsurface structure with at least one, often more than one, of a containment formation and a caprock above an injection zone into which the waste is injected. According to one or more embodiments, the subsurface structure may have one or more relatively impermeable layers to seal the top of the structure. Preferably, the subsurface structure that the waste is injected into may have reasonable permeability and porosity. When the substructure surface includes a relatively impermeable layer having a higher fracture gradient, this layer should impede upward migration of the waste and contain the sequestrated waste within the formation. In embodiments where multiple formation types are possible as an injection zone, the selection of a permeable and porous subsurface structure may be accompanied by subsurface structures having low fracture gradient and formation pressure. Government regulations may also dictate geological requirements for sequestration.

Furthermore, a well may be drilled and completed according to special requirements set forth by governmental regulations and by the waste to be injected. The government regulations are typically set forth to protect the underground safe drinking water from contamination through the use of monitoring devices in the selected subsurface structure as well as any adjacent wells. Well completion may include selecting equipment such as the tubulars, packers and downhole tools that is compatible with the waste, injection rate, pressure and monitoring requirements.

Once the characteristics of the subsurface structure have been determined, the characteristics may be used to inform the desired characteristics of the slurry and therefore the ultimate conditioning requirements. Thus, battery recycling waste streams may be analyzed to determine conditioning requirements for sequestration. As an example, a waste slurry and formation may be evaluated to provide compatibility with the formation fluid and the formation itself. Furthermore, formation porosity can determine slurry processing requirements in terms of grinding and particle size. For example, injection zones of high porosity and permeability can accept larger particles and thus less grinding is required.

In addition to the method of preparing the subsurface structure for sequestration of battery recycle waste streams, testing and monitoring of the structure after injection may be performed. According to one or more embodiments, after injection of injected slurry, a testing and monitoring apparatus may be used to perform procedures and analyses related to safe containment and long-term environmental integrity. The procedure and analyses used to adhere to environmental requirements and to ensure safe containment of the sequestrated waste may include subsurface geomechanics, hydraulic fracturing and reservoir simulation studies to evaluate the integrity of the containment formation, maximum allowed injection pressure, the volume of waste that can be safely sequestrated in a well or the well capacity, the waste plume as a function of time, among others. According to at least one embodiment, the testing may be periodic and comprise well mechanical integrity test, step-rate, diagnostic fracture injection test, pressure fall off testing.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A method of producing an injection slurry for the sequestration of battery recycling waste, the method comprising:
contacting at least one battery recycling waste stream with an optional liquid, thereby forming a slurry;
screening the slurry thereby forming a screened slurry;
conditioning the screened slurry thereby forming a conditioned slurry; and
determining whether a threshold injection criterion of the conditioned slurry has been met, wherein when the threshold injection criterion has been met, an injection slurry is thereby formed.

2. The method of claim 1, further comprising, prior to the contacting step, collecting at least one battery recycling waste stream from a battery production process.

3. The method of claim 1, wherein the method is performed continuously.

4. The method of claim 1, wherein the method is performed in batches.

5. The method of claim 1, wherein the at least one battery recycling waste stream comprises at least one of a solid component and a liquid component.

6. The method of claim 5, wherein the solid component is selected from the group consisting of sodium sulfate, iron phosphate, graphite, plastics, slags, sludges, Na₂SO₄, FePO₄, Al(OH)₃, Fe(OH)₃, and mixtures thereof.

7. The method of claim 5, wherein the liquid component comprises one or more of water, dissolved salts, suspended graphite, suspended fine particles, dissolved Na₂SO₄, NaOH, and wastewater.

8. The method of claim 1, wherein the optional liquid is selected from the group consisting of water, a battery recycling process stream, and combinations thereof.

9. The method of claim 1, wherein the contacting step further comprises grinding and/or mixing.

10. The method of claim 1, further comprising, after the contacting step:
feeding the slurry into an inlet of a pump; and
discharging the slurry into at least one screener.

11. The method of claim 1, wherein the screening step further comprises separating materials larger than a threshold size of 2 mm.

12. The method of claim 11, further comprising, after the screening step, discharging the materials larger than the threshold size to an outlet connected to a process line returning to repeat the contacting and screening steps.

13. The method of claim 1, wherein the conditioning step comprises a second contacting step of contacting the screened slurry with one or more chemical additive.

14. The method of claim 13, wherein the one or more chemical additive is selected from the group consisting of biocide, corrosion inhibitor, pH adjuster, viscosifier, and combinations thereof.

15. The method of claim 1, further comprising, after the conditioning step, discharging the conditioned slurry into a vessel.

16. The method of claim 1, wherein the threshold injection criterion is selected from the group consisting of slurry pH, slurry density, slurry viscosity, solids content of the slurry, solid particle size, and combinations thereof.

17. The method of claim 1, wherein when the threshold injection criterion is not met, repeating the contacting, screening, conditioning and determining steps.

18. A method of sequestering battery waste, the method comprising:
introducing an injection slurry comprising battery recycling waste into a subsurface structure at a depth of at least 500 m.

19. The method of claim 18, further comprising:
acquiring data for real-time monitoring of injection pressure, build-up pressure, pumping rate, and slurry density.

20. The method of claim 18 further comprising, before introducing the injection slurry:
selecting a permeable and porous subsurface structure with at least one of a containment formation and caprock above the subsurface structure.

21. The method of claim 18, further comprising:
analyzing battery recycling waste streams to determine conditioning requirements for sequestration.

22. The method of claim 18, further comprising:
testing the subsurface structure to determine a target injection zone and injection pressure.
